(19) United States
(12) Patent Application Publication
(10) Pub. No.: US 2025/0238703 A1
(43) Pub. Date: Jul. 24, 2025

(54) QUANTUM COMPUTING DEVICE AND QUANTUM ERROR CORRECTION METHOD THEREOF

(71) Applicant: SEOUL NATIONAL UNIVERSITY R&DB FOUNDATION, Seoul (KR)

(72) Inventors: Taehyun KIM, Seoul (KR); Jeonghoon LEE, Daegu (KR)

(73) Assignee: SEOUL NATIONAL UNIVERSITY R&DB FOUNDATION, Seoul (KR)

(21) Appl. No.: 18/429,810

(22) Filed: Feb. 1, 2024

(30) Foreign Application Priority Data
Feb. 3, 2023 (KR) 10-2023-0015102

(51) Int. Cl. G06N 10/70; G06N 10/40

(52) U.S. Cl. CPC G06N 10/70; G06N 10/40

(57) ABSTRACT

A quantum computing device according to an aspect of the present disclosure includes an ion trap chip including direct current (DC) electrodes and radio frequency (RF) rails to form a plurality of horizontal traps and one or morevertical traps, and a controller configured to trap ions by controlling the ion trap chip, adjust positions of the ions, and apply laser beam to the ions to perform gate operations. The controller performs traversal gate operations between qubits arranged in the horizontal trap area based on qubit connectivity of only qubits trapped in the same horizontal trap, moves the qubits arranged in the horizontal trap area to the vertical trap adjacent to the horizontal trap area through parallel shuttling, perform quantum error correction, and continues traversal gate operations after shuttling to an adjacent horizontal trap area through parallel shuttling.

### CROSS-REFERENCE TO RELATED APPLICATION

This application is based on and claims priority under 35 U.S.C. § 119 to Korean Patent Application No. 10-2023-0015012, filed on Feb. 3, 2023, in the Korean Intellectual Property Office, the disclosure of which is incorporated by reference herein in its entirety.

### BACKGROUND

The present disclosure relates to a quantum computing device based on ion trap and a quantum error correction method.

Quantum computers are computational mechanical devices that utilize quantum mechanical phenomena, such as quantum superposition and quantum entanglement, and are expected to perform calculations that classical computers may not perform or perform faster calculations for certain problems. A qubit, the fundamental processing unit of a quantum computer, can be implemented in various forms, such as a photon in photonic systems, an ion in trapped ion systems, a spin in quantum dot systems, and a superconducting circuit in superconducting systems. Among the qubits, the trapped ion qubit is known to undergo a process of trapping ions, state initialization, a gate operation through quantum state manipulation, and state measurement. In this case, a method of generating a harmonic well using a radio frequency (RF) signal to trap many ions arranged in a row is used as a method to trap ions.

FIG. 1 is a view illustrating a chip configuration for an ion trap of a conventionally known quantum computer.

As illustrated in FIG. 1, an ion trap chip includes a pair of inner direct current (DC) electrodes spaced apart from each other by a predetermined distance and extending in parallel to each other, a pair of RF rails extending in parallel to the pair of inner DC electrodes, and a plurality of outer DC electrodes arranged in parallel to each other in a direction perpendicular to the an extension direction of the pair of inner DC electrodes, which are formed on a surface of a substrate. The ion trap chip forms a potential by using the inner DC electrodes, the outer DC electrodes, and the RF rails and traps the positively charged ions at a desired position. It can be seen from FIG. 1 that ions illustrated by black dots are trapped above a loading slot between the inner DC electrodes. Afterwards, a voltage applied to the DC electrodes may be adjusted to change a shape of the potential and move the trapped ions. A more detailed configuration of the ion trap chip is disclosed in a document written by the inventor of the present disclosure (“Experimental Methods for Trapping Ions Using Microfabricated Surface Ion Traps: “Journal of Visualized Experiments, 2017”).

Meanwhile, an ion trap-based quantum computer implements a quantum gate that changes a state of qubits by applying laser beam with a frequency that matches an energy structure of ions for an appropriate amount of time. In addition, interactions such as a two-qubit gate can occur between ions trapped in the same potential regardless of the distance between them, and it is said that there is connectivity between qubits that allows the desired interaction to occur immediately without additional gate operations. However, when the number of ions trapped in the same trap increases, a buckling problem may occur where the ions are not aligned in a row. Also, there is a problem that an interval between ions changes depending on their positions and an ion interval at the center of a trap becomes too narrow, making a precise laser focusing on the desired ion challenging, and causing a crosstalk which may decrease the qubit fidelity. To solve this problem, an ion trap chip structure called quantum charge coupled device (QCCD) was presented, where several DC electrodes and RF rails form a complex array-like structure including paths between trapping regions and junctions connecting several paths. In QCCD, ions are initially trapped in the trapping region called memory region, and if the interaction between multiple ions in different memory regions is required, corresponding ions move along the paths and junctions to meet in the trapping region called interaction region. In this case, moving ions by changing the voltage applied to DC electrodes to change the shape of the potential is called ion shuttling.

However, with current technology, it is hard to make a quantum computer that can individually manipulate more than 100 trapped ions, and there is not much research to optimize the modularized ion trap system described above. The ion trap chip structures proposed so far are general-purpose structure that can implement arbitrary quantum circuits, but it is possible to optimize the chip structure and the order of laser sequence or electrical signals by considering the patterns or rules in the quantum circuits thereby reducing the time and space to run the quantum circuit.

Unlike a bit, that is an information processing unit of current computers, a qubit easily loses information and is greatly affected by external noise. Therefore, it is mandatory to store quantum information with redundant qubits and recover the original information even if some qubits undergo the error. This process is called quantum error correction (QEC) where one logical qubit of information is encoded in multiple ions (or physical qubits) according to the encoding quantum circuit, and information of errors in physical qubits can be extracted with syndrome extraction circuit. It is also possible to do logical gates on logical qubits without decoding the stored information, but if the logical gate operation requires complex interactions between physical qubits, error in one physical qubit may propagate to other physical qubits and deteriorate the quality of the process. Fault-tolerant quantum computing means that an error in one quantum circuit component does not propagate to other components with high probability if the physical error probability is low enough, and transversal gate is one way to do logical gate operations fault-tolerantly. Transversal gate operations require only one-qubit gate to each physical qubit or pairwise physical qubit interaction between two logical qubits, so that multi-qubit gate between physical qubits in one logical qubit does not exist, and error propagation within one logical qubit is fundamentally prevented.

Because of this advantage, it is likely that the QEC code with large set of transversal gates is used practically, and it is possible to optimize the chip architecture by exploiting the pattern of transversal gates and non-transversal gate or QEC process.

While the transversal gate requires only pairwise interactions between physical qubits in different logical qubits, non-transversal gate such as T gate and QEC process on one logical qubit require only interactions between physical qubits in one logical qubit. Therefore, there is clear separation of required qubit connectivity, but there is no known ion trap chip where this separation is reflected into design the chip.

The present disclosure proposes an ion trap chip having a new structure that separates traps in which transversal gates in a quantum circuit is implemented and traps in which other non-transversal gates and QEC process occur.

An example of related art includes Korea Patent Publication No. 10-2022-0129645 (Title of invention: Quantum logic gate design and optimization)

### SUMMARY

In order to solve the problems described above, the present disclosure provides a quantum computing device which uses an ion trap chip having a new structure that separates traps where transversal gates occur and traps where other non-transversal gates and QEC process occur.

However, technical problems to be solved by the present embodiment are not limited to the technical problems described above, and there may be other technical problems.

To solve the above problems, a quantum computing device according to an aspect of the present disclosure includes an ion trap chip including direct current (DC) electrodes and radio frequency (RF) rails to form a plurality of horizontal traps and one or more vertical traps, and a controller configured to trap ions by controlling the ion trap chip, allocate qubits to trapped ions, adjust positions of the ions, and apply laser beam to the ions to perform traversal gate operations, non-traversal gate operations, and quantum error correction. In this case, the controller performs the traversal gate operations based on qubit connectivity of only qubits trapped in the same horizontal trap, moves the qubits arranged in the horizontal trap to a vertical trap adjacent to the horizontal trap through parallel shuttling, and then performs quantum error correction and non-transversal gates.

In addition, an ion trap chip according to another aspect of the present disclosure includes the first horizontal trap area in which the N horizontal traps are arranged in parallel to each other, the second horizontal trap area which is adjacent to the first horizontal trap area and in which the N horizontal traps are arranged in parallel to each other, and a vertical trap disposed between the first horizontal trap area and the second horizontal trap area, wherein a first logical qubit represented by N ions arranged in the same column in the first horizontal trap area is moved to the vertical trap through parallel shuttling of the N ions, quantum error correction is performed on the first logical qubit arranged in the vertical trap based on qubit connectivity of only qubits arranged in the vertical trap, and the N ions of the first logical qubit move to the N horizontal traps of the second horizontal trap area through parallel shuttling.

In addition, according to another aspect of the present disclosure, a quantum error correction method of a quantum computing device including an ion trap chip in which a plurality of horizontal traps and one or more vertical traps are formed, includes moving, by a controller, qubits, which are arranged in the first horizontal trap area of the ion trap chip and on which traversal gate operations using qubit connectivity in each horizontal trap are applied, to the vertical trap adjacent to the first horizontal trap area through parallel shuttling, performing quantum error correction on the qubits moved to the vertical trap based on the qubit connectivity of only the qubits trapped in the vertical trap, and moving in parallel the qubits, on which the quantum error correction is performed, to the second horizontal trap area adjacent to the vertical trap.

### BRIEF DESCRIPTION OF THE DRAWINGS

Embodiments of the inventive concept will be more clearly understood from the following detailed description taken in conjunction with the accompanying drawings in which:

FIG. 1 is a view illustrating a chip configuration for ion trap of a conventionally known quantum computer;

FIG. 2 is a block diagram illustrating a configuration of a quantum computing device according to an embodiment of the present disclosure;

FIG. 3 is a view illustrating a detailed configuration of an ion trap chip according to an embodiment of the present disclosure;

FIG. 4 is a view illustrating an ion movement process of a quantum computing device according to an embodiment of the present disclosure;

FIGS. 5 to 8 are views illustrating a quantum error correction (QEC) process of a quantum computing device according to an embodiment of the present disclosure; and

FIG. 9 is a flowchart illustrating a quantum error correction method performed by a quantum computing device, according to an embodiment of the present disclosure.

### DETAILED DESCRIPTION OF THE EMBODIMENTS

Hereinafter, embodiments of the present disclosure will be described in detail with reference to the accompanying drawings such that those skilled in the art in which the present disclosure belongs may easily practice the present disclosure. However, the present disclosure may be implemented in many different forms and is not limited to the embodiments described herein. In addition, in order to clearly describe the present disclosure, parts irrelevant to the description are omitted in the drawings, and similar reference numerals are attached to similar parts throughout the specification.

When it is described that a portion is “connected” to another portion throughout the specification, this includes not only a case where the portion is “directly connected” to another portion but also a case where the portion is “electrically connected” to another portion with another component therebetween. In addition, when it is described that a portion “includes” a certain component, this means that the portion may further include another component without excluding another component unless otherwise stated.

In the present disclosure, a “portion” includes a unit realized by hardware, a unit realized by software, and a unit realized by using both. In addition, one unit may be realized by using two or more pieces of hardware, and two or more units may be realized by using one piece of hardware. Meanwhile, a “˜ portion” is not limited to software or hardware, and a “˜ portion” may be configured to be included in an addressable storage medium or may be configured to reproduce one or more processors. Therefore, in one example, “˜ portion” refers to components, such as software components, object-oriented software components, class components, and task components, and includes processes, functions, properties, and procedures, subroutines, segments of program code, drivers, firmware, microcode, circuits, data, databases, data structures, tables, arrays, and variables. The functions provided within the components and “portions” may be combined into a smaller number of components and “portions” or may be further separated into additional components and “portions”. Additionally, components and “portions” may be implemented to regenerate a device or one or more central processing units (CPUs).

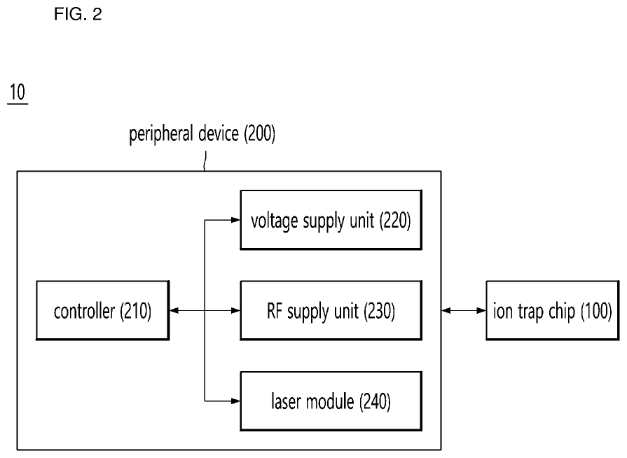

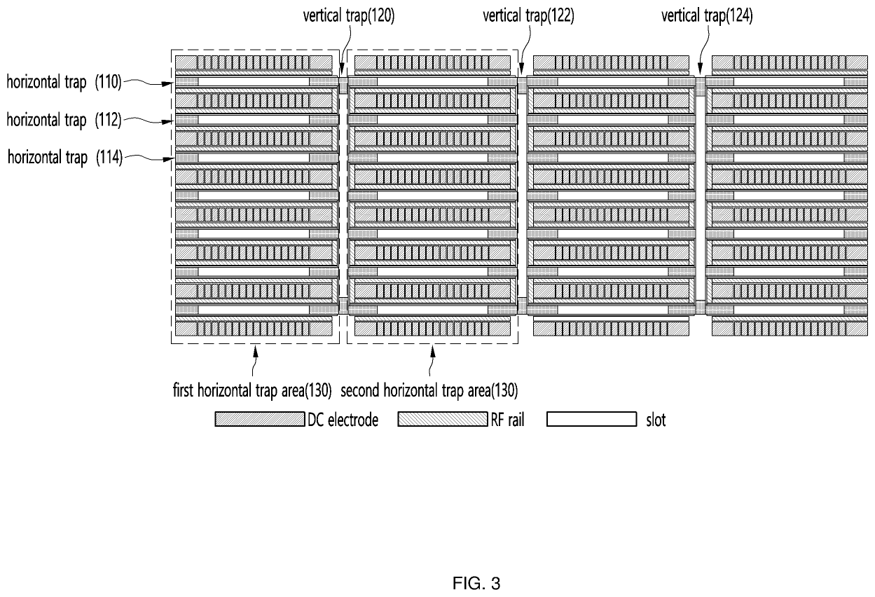

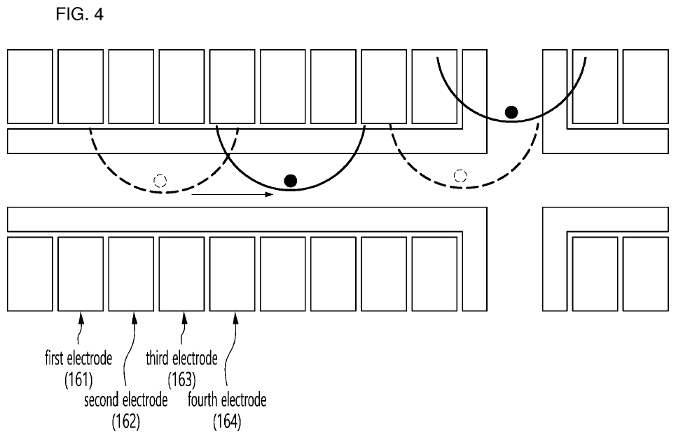

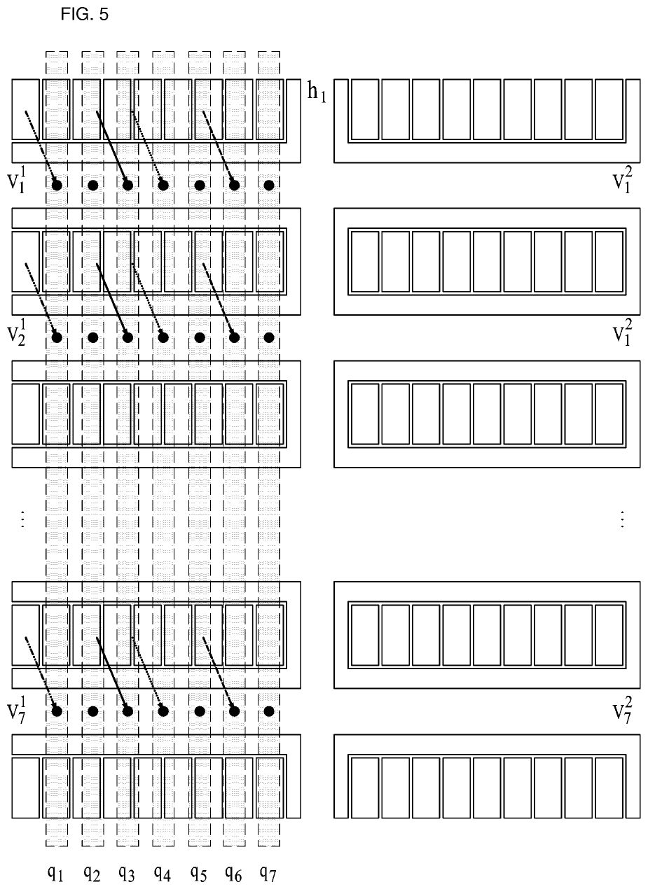

FIG. 2 is a block diagram illustrating a configuration of a quantum computing device according to an embodiment of the present disclosure, FIG. 3 is a view illustrating a detailed configuration of an ion trap chip 100 according to an embodiment of the present disclosure, FIG. 4 is a view illustrating an ion movement process of a quantum computing device according to an embodiment of the present disclosure, and FIGS. 5 to 8 are views illustrating a quantum error correction (QEC) process of a quantum computing device according to an embodiment of the present disclosure.

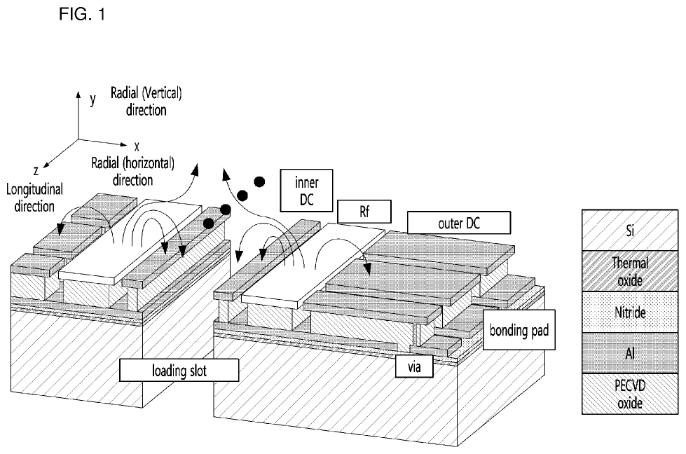

A quantum computing device 10 includes the ion trap chip 100 and a peripheral device 200. As illustrated in FIGS. 1 and 3 described above, the ion trap chip 100 includes direct current (DC) electrodes and radio frequency (RF) rails to form a plurality of horizontal traps 110, 112, and 114 and a plurality of vertical traps 120, 122, and 124. As illustrated, the plurality of horizontal traps 110, 112, and 114 extend in a horizontal direction and are arranged between RF rails facing each other. In addition, the DC electrodes are arranged along the RC rails, and an extension direction of outer DC electrodes is perpendicular to an extension direction of the plurality of horizontal traps 110, 112, and 114. Also, the plurality of vertical traps 120, 122, and 124 extend in a vertical direction and are arranged between RF rails facing each other.

The ion trap chip 100 includes the first horizontal trap area 130 in which N horizontal traps are arranged in parallel to each other, the second horizontal trap area 140 which is disposed adjacent to the first horizontal trap area 130 and in which N horizontal traps arranged in parallel to each other, and the vertical trap 120 disposed between the first horizontal trap area 130 and the second horizontal trap area 140. In this case, two or more horizontal trap areas may be provided, and the vertical trap 120 is disposed between the first horizontal trap area 130 and the second horizontal trap 140 adjacent to each other. For reference, a structure of the ion trap chip 100 illustrated in FIG. 3 illustrates a case where the structure is designed based on the Steane code that is the smallest color code which is one of the QEC codes.

Meanwhile, when manufacturing the ion trap chip 100 through an actual process, a shape of the ion trap chip 100 may change depending on limitations of materials and technology to be used. Also, a trap for transversal gates is disposed in a horizontal direction, and a trap for non-transversal gates is disposed in a vertical direction. Voltages applied to DC electrodes around the trap for transversal gates may be independent of each other, but it is assumed in the structure of FIG. 3 that all DC electrodes in the same column are connected to each other and have the same voltage and a passage connecting the DC electrodes to each other is in a lower layer. It is expected that hundreds of trap areas may be implemented on one chip with the current level of technology but may change depending on sizes of wafers, traps, and electrodes used in a manufacturing process. In this case, individual lasers are required to control thousands or more trapped ions, and the lasers have to be emitted perpendicular to the chip surface to reduce complexity. In this case, it is assumed that each trap is open at the bottom or filled with a transparent material, such as glass, to prevent the laser from damaging the chip (white slots in FIG. 3).

Next, the peripheral device 200 includes a controller 210, a voltage supply unit 220, an RF supply unit 230, and a laser module 240.

The voltage supply unit 220 supplies driving voltages respectively to inner DC electrodes and outer DC electrodes arranged in the ion trap chip 100. Also, the RF supply unit 230 supplies an RF signal for ion trap through the RF rails. The laser module 240 adjusts a state of trapped ions or emits a laser to the ion trap chip 100 to measure the ion state.

The controller 210 controls the voltage supply unit 220 and the RF supply unit 230 to trap ions by controlling a voltage applied to the DC electrodes of the ion trap chip 100 and an RF voltage applied to the RF rails, allocates qubits to the trapped ions, and adjusts positions of the ions. Also, the controller 210 applies laser beam to ions by using the laser module 240 to perform traversal gate operations, non-traversal gate operations, and QEC to run the quantum computing device 10.

In particular, the controller 210 performs the traversal gate operations based on qubit connectivity of only qubits arranged in the same horizontal trap for QEC, and after completion of the traversal gate operations, the qubits arranged in the same column of the horizontal trap are moved to the vertical trap adjacent to the horizontal trap through parallel shuttling, and QEC is performed on the qubits. When N ions arranged in the same column in N horizontal traps arranged in parallel to each other constitute one logical qubit, the traversal gate operations are performed based on only qubit connectivity between qubits trapped in the same horizontal trap. Also, QEC is performed based on the qubit connectivity of only the qubits placed in the vertical trap.

Referring to FIG. 4, the controller 210 may control an operation of the voltage supply unit 220 to move the ions trapped in the horizontal traps along the horizontal direction and then move the trapped ions to the adjacent vertical trap. For example, when a negative voltage is applied to the second electrode 162 and the third electrode 163 illustrated in FIG. 4 and a positive voltage is applied to the first electrode 161 and the fourth electrode 165, electric fields illustrated by dotted lines are formed, and then, when the pattern of the voltages shifts to adjacent electrodes, the electric field also moves along the horizontal direction, and trapped ions also move along the horizontal direction.

Next, a traversal gate operation and QEC processing performed by the controller 210 are described in detail.

For the ion trap chip 100, the controller 210 performs steps of 1) trapping ions, 2) state initialization, 3) gate operation, QEC, and state initialization, and 4) measurement. In this case, the trapping ions may be performed once at the start of the entire operation, and the remaining steps (the state initialization, the gate operation, the QEC and state initialization, and the measurement) may be performed repeatedly in the form of a subroutine and may be almost similar to the trap currently used.

When assuming in the ion trap chip 10 of FIG. 3 that ions are trapped in the leftmost horizontal trap, the controller 210 may perform traversal gate operations by applying laser beam in a direction perpendicular to a surface of the ion trap chip 100 through the laser module 240. As illustrated in FIGS. 5 to 7, ions with the same order in each horizontal trap, that is, ions in the same column, represent logical qubits q1 to q7, thereby operating in the same manner.

When QEC is required, the controller 210 changes voltages of DC electrodes to move ions in the horizontal direction, and thereby, qubits in the same column pass through the horizontal traps to be placed in the vertical trap. Through QEC, the controller 210 corrects an error through appropriate operations between qubits representing one logical qubit, and when QEC is completed, the voltages of the DC electrodes are changed again to move the ions to the next horizontal traps. Accordingly, a first logical qubit composed of N ions arranged in the same column of the first horizontal trap area 130 moves to the vertical trap 120 through parallel shuttling of the N ions. Then, the controller 210 performs QEC on the logical qubit placed in the vertical trap 120.

By repeating this process, an intended circuit may be implemented by periodically performing QEC on all logical qubits. Meanwhile, if the interaction between two or more logical qubits in different horizontal trap region is required, a process of moving qubits to the same trap through swapping (SWAP) operations and shuttling operations may be required.

In more detail with reference to the drawings, the controller 210 may implement a quantum gate by applying laser beam to ions trapped in the same trap as illustrated in FIG. 5. In this case, a plurality of ions grouped in a dotted block represent one logical qubit encoded with a QEC code. When applying a transversal gate operation to the used QEC code, a gate operation may be performed simply by applying the same gate operation only to the ions in the same horizontal trap without interaction between ions within one dotted line block. Meanwhile, a QEC algorithm itself corresponds to the known technology, and accordingly, detailed descriptions thereof are omitted.

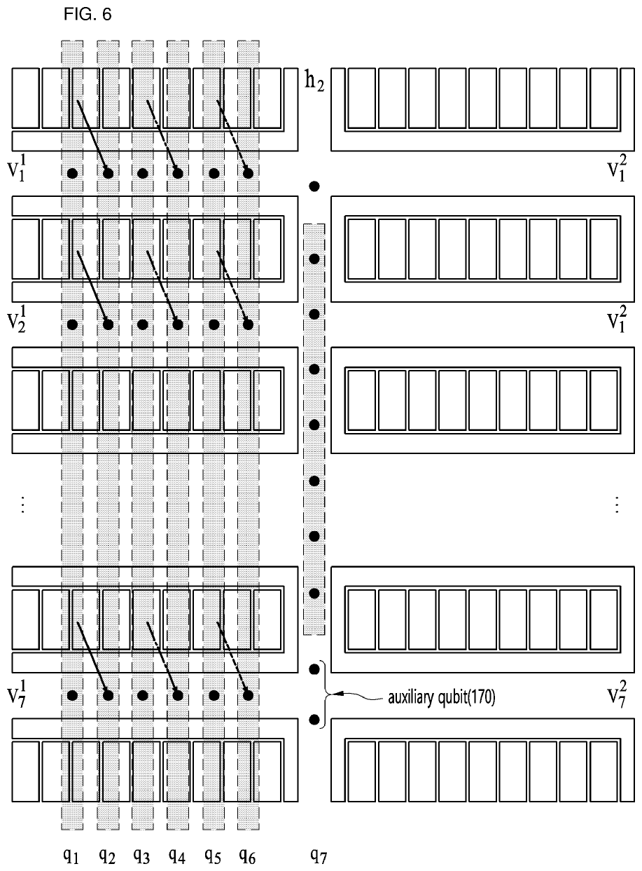

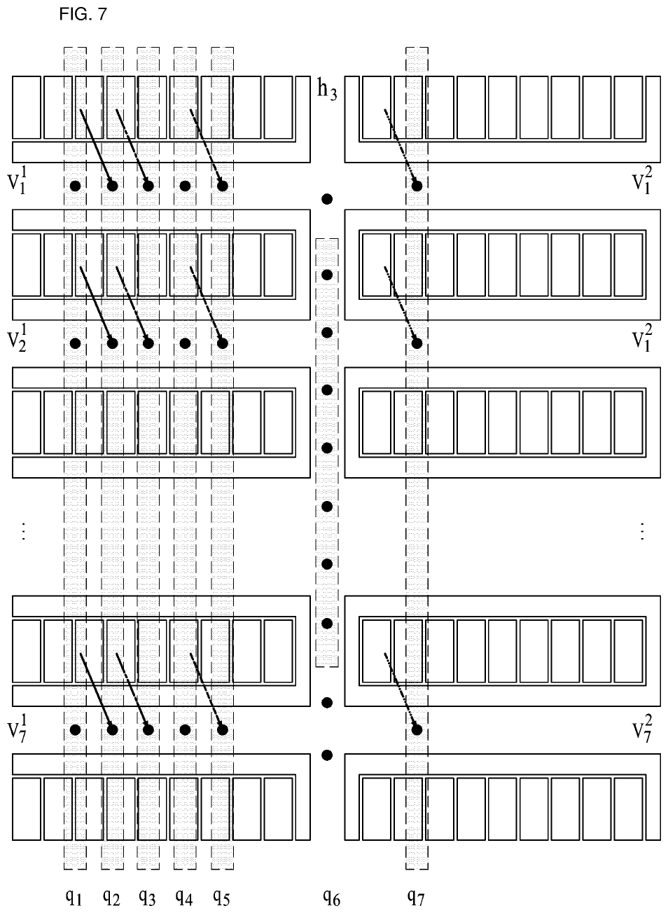

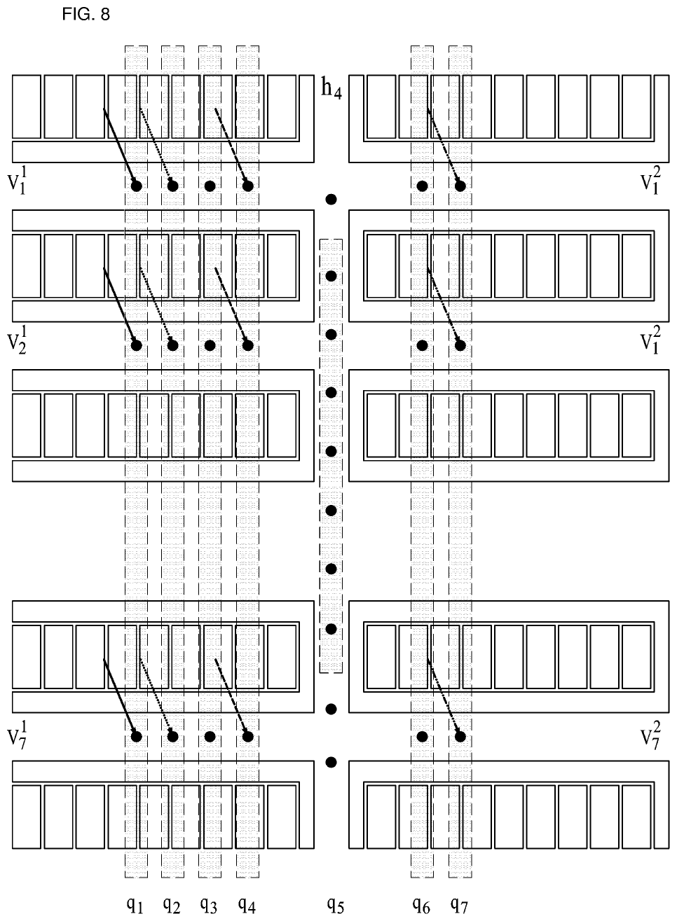

As illustrated in FIG. 6, ions move to a vertical trap through shuttling, and then QEC and a non-transversal gate operation are performed. For the logical qubit q7 in a vertical trap where a non-transversal gate operation occurs, information of the error (error syndrome) can be detected and corrected by executing syndrome extraction circuit with additional auxiliary qubit (170, Ancilla qubit). Then, as illustrated in FIG. 7, the quantum error-corrected qubit q7 is moved to an adjacent horizontal trap area through shuttling. Then, the process described with reference to FIGS. 5 and 6 is repeatedly performed as illustrated in FIG. 8.

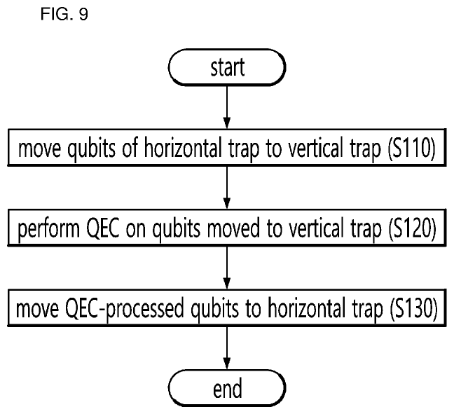

FIG. 9 is a flowchart illustrating a quantum error correction method performed by a quantum computing device, according to an embodiment of the present disclosure.

First, the controller 210 of the quantum computing device 10 moves the qubits placed in the horizontal traps of the ion trap chip 100 to the vertical trap adjacent to the horizontal traps through shuttling (S110). That is, as illustrated in FIGS. 5 and 6, the ions placed in the horizontal traps in the same column are moved to the vertical trap through parallel shuttling.

Next, after syndrome extraction circuit containing the qubits representing one logical qubit and additional ancilla qubits is executed, states of the ancilla qubits placed in the vertical trap are measured, and QEC processing is performed on the qubits (S120).

Next, the quantum error-corrected qubits are moved in parallel to an adjacent horizontal trap area through shuttling (S130). That is, the qubits placed in the first horizontal trap area 130 are moved to the vertical trap 120 for QEC processing, and then the QEC-processed qubits are moved to the second horizontal trap area 140.

According to this method, QEC is performed in the vertical trap after one or more traversal gate operations, and thus, the error probability of the logical qubit may be reduced.

According to the solution to the above-described problem, the present disclosure may implement a quantum computing device capable of efficient processing of QEC.

When arranging ions in a trap according to the known chip structure, many SWAP gate operations or shuttling operations have to be used for 2-qubit gate operation. Meanwhile, when dividing areas as proposed in the present disclosure, traversal gate operations and shuttling operations are performed along horizontal traps, and when qubits reach the vertical trap, the arrived qubits are aligned in the vertical direction to implement a QEC process or non-transversal gate operations. Because the required qubit connectivity switches between horizontal and vertical direction, reflecting the qubit connectivity into the chip layout as the present disclosure can lower the distance of qubit shuttling, remove the unnecessary shuttling and SWAP operations, and decrease the time complexity and error probability.

Naturally, by moving a logical qubit in one direction on the chip in the present disclosure, the logical qubit passes through both the trap where transversal gates occur and the trap where other non-transversal gates and QEC process occur, and the logical qubit experiences both types of operations alternatively. In essence, the pattern of required qubit connectivity is reflected in the chip layout, enabling logical qubits to perform various operations simply by being placed in the appropriate trap region, without the need for a large number of additional shuttling operations. In this way, logical qubits can complete the gate operations required to run the quantum circuit, while also having chances for the error correction in the middle of gate operations with only small overheads.

A method according to one embodiment of the present disclosure may be implemented in the form of a recording medium including instructions executable by a computer, such as a program module executed by a computer. A computer readable medium may be any available medium that may be accessed by a computer and includes both volatile and nonvolatile media, removable and non-removable media. Also, the computer readable medium may include a computer storage medium. A computer storage medium includes both volatile and nonvolatile media and removable and non-removable media implemented by any method or technology for storing information, such as computer readable instructions, data structures, program modules or other data.

Although the method and systems of the present disclosure are described with reference to specific embodiments, some or all of their components or operations may be implemented by using a computer system having a general-purpose hardware architecture.

The above description of the present disclosure is for illustrative purposes, and those skilled in the art to which the present disclosure belongs will understand that the present disclosure may be easily modified into another specific form without changing the technical idea or essential features of the present disclosure. Therefore, the embodiments described above should be understood as illustrative in all respects and not limiting. For example, each component described as a single type may be implemented in a distributed manner, and likewise, components described as distributed may be implemented in a combined form.

The scope of the present disclosure is indicated by the following claims rather than the detailed description above, and the meaning and scope of the claims and all changes or modifications derived from the equivalent concepts should be interpreted as being included in the scope of the present disclosure.

What is claimed is:

1. A quantum computing device comprising:
an ion trap chip including direct current (DC) electrodes and radio frequency (RF) rails to form a plurality of horizontal traps and one or morevertical traps; and
a controller configured to trap ions by controlling the ion trap chip, allocate qubits to trapped ions, adjust positions of the ions, and apply laser beam to the ions to perform traversal gate operations, non-traversal gate operations, and quantum error correction,
wherein the controller performs the traversal gate operation based on qubit connectivity of only qubits trapped in the same horizontal trap, moves the qubits trapped in the horizontal trap to a vertical trap adjacent to the horizontal trap through parallel shuttling, and then performs quantum error correction and non-transversal gate operation.

2. The quantum computing device of claim 1, wherein
N ions arranged in the same column in N horizontal traps arranged in parallel to each other constitute one logical qubit, and
the controller performs the traversal gate operation on a first logical qubit and a second logical qubit arranged in different columns.

3. The quantum computing device of 1, wherein
the ion trap chip includes the first horizontal trap area in which the N horizontal traps are arranged in parallel to each other, the second horizontal trap area which is adjacent to the first horizontal trap area and in which the N horizontal traps are arranged in parallel to each other, and a vertical trap disposed between the first horizontal trap area and the second horizontal trap area, and
the controller moves a first logical qubit represented by N ions arranged in the same column in the first horizontal trap area to the vertical trap through the parallel shuttling, performs quantum error correction and non-transversal gate operation, and moves the first logical qubit to the second horizontal trap area through the parallel shuttling.

4. An ion trap chip comprising:
a first horizontal trap area in which the N horizontal traps are arranged in parallel to each other;
a second horizontal trap area which is adjacent to the first horizontal trap area and in which the N horizontal traps are arranged in parallel to each other; and
a vertical trap disposed between the first horizontal trap area and the second horizontal trap area,
wherein a first logical qubit represented by N ions arranged in the same column in the first horizontal trap area is moved to the vertical trap through parallel shuttling of the N ions,
quantum error correction is performed on the first logical qubit arranged in the vertical trap,
after the quantum error correction, the N ions of the first logical qubit move to the N horizontal traps of the second horizontal trap area through shuttling, and
the quantum error correction is performed based on qubit connectivity of only qubits trapped in the vertical trap.

5. A quantum error correction method of a quantum computing device including an ion trap chip in which a plurality of horizontal traps and one or more vertical traps are formed, the quantum error correction method comprising:
moving, by a controller, qubits, which are arranged in the first horizontal trap area of the ion trap chip and on which traversal gate operations using qubit connectivity in a horizontal direction are completed, to the vertical trap adjacent to a first horizontal trap area through parallel shuttling;
performing quantum error correction on the qubits moved to the vertical trap based on the qubit connectivity of only the qubits trapped in the vertical trap; and
moving in parallel the qubits, on which the quantum error correction is performed, to a second horizontal trap area adjacent to the vertical trap.

6. The quantum error correction method of claim 5, wherein
the ion trap chip includes the first horizontal trap area in which N horizontal traps are arranged in parallel to each other, the second horizontal trap area which is adjacent to the first horizontal trap area and in which the N horizontal traps are arranged in parallel to each other, and the vertical trap disposed between the first horizontal trap area and the second horizontal trap area, and
in the moving of the qubits, a first logical qubit represented by N ions arranged in the same column in the first horizontal trap area is moved to the vertical trap through the parallel shuttling,
in the performing of the quantum error correction, the quantum error correction is performed on the first logical qubit moved to the vertical trap, and
in the moving in parallel of the qubits, the first logical qubit on which the quantum error correction is performed is moved to the second horizontal trap area.

7. A non-transitory computer-readable recording medium in which a computer program for performing the quantum error correction method according to claim 5 is recorded.

8. A non-transitory computer-readable recording medium in which a computer program for performing the quantum error correction method according to claim 6 is recorded.
